(19) United States
(12) Patent Application Publication
(10) Pub. No.: US 2008/0012188 A1
(43) Pub. Date: Jan. 17, 2008

(54) ONE-PIECE MICROCELLULAR POLYURETHANE INSULATOR HAVING DIFFERENT DENSITIES

(76) Inventor: DANIEL G. DICKSON, West Bloomfield, MI (US)

Correspondence Address: BASF AKTIENGESELLSCHAFT, CARL-BOSCH STRASSE 38, 67056 LUDWIGSHAFEN, LUDWIGSHAFEN, 69056, omitted

(21) Appl. No.: 11/457,882

(22) Filed: Jul. 17, 2006

(51) Int. Cl. F16M 1/00

(52) U.S. Cl. 267/139

(57) ABSTRACT

An insulator for a vehicle includes a first portion extending along an axis, an intermediate portion extending from the first portion along the axis, and a second portion extending from the intermediate portion along the axis. The first portion defines a first density and the second portion defines a second density different from the first density. Preferably, the first density is greater than the second density such that the second portion is more compressible than the first portion. The first portion, the intermediate portion, and the second portion are integrally formed of a common homogeneous microcellular polyurethane material for defining a one-piece insulator having different densities. In exemplary embodiments, the insulator is further defined as a jounce bumper or a coil spring isolator for disposition in a wheel suspension system, and a body insulator for disposition in a mount assembly of a vehicle.

### BACKGROUND OF THE INVENTION

1. Field of the Invention

The present invention relates to an insulator for a vehicle which can be utilized as a jounce bumper or a coil spring isolator for disposition in a wheel suspension system, or a body insulator for disposition in a mount assembly of a vehicle.

2. Description of the Related Art

Insulators for absorbing loads and dampening vibrations in vehicles are known in the prior art. Such insulators include jounce bumpers and coil spring isolators for disposition in wheel suspension systems, and body insulators for disposition in mount assemblies. Insulators of these types are formed from elastomeric materials such as rubber or microcellular polyurethane (MCU). MCU provides several advantages over alternative materials. Specifically, MCU has a microcellular structure, i.e., the MCU presents cell walls defining cells, or void space. When not subject to compressive forces, the cell walls have an original shape and the cells are generally filled with air. When the insulator formed of MCU is subjected to compressive forces, the cell walls are collapsed and air evacuates from the cells and the insulator is thereby deformed. When the compressive forces are removed from the insulator, the cell walls return to the original shape and the insulator thereby regains its form. Because the cell walls collapse when subject to compressive forces, the insulator experiences minimal bulge when compressed. In addition, at relatively low loads the insulator compresses and absorbs loads, i.e. the MCU has a progressive load deflection. Because the cell walls are collapsing, as the load increases, the insulator becomes less compressible. When the cell walls are completely collapsed, the insulator is not compressible and thereby provides a block height.

Differences in the density of the MCU effects the impact isolating characteristics of the insulator. Insulators can be formed of a relatively low density MCU so as to be conducive to absorbing loads and dampening vibrations. Specifically, at the relatively low density, the cells of the MCU are relatively larger and the MCU is therefore more compressible than relatively high density MCU. Alternatively, insulators can be formed of relatively high density MCU so as to provide an increased block height. Specifically, at the relatively high density, the cells of the MCU are relatively smaller and the MCU is therefore less compressible. It follows that relatively low density MCU is more compressible than the relatively high density MCU and therefore provides less block height than the relatively high density MCU. Also, relatively high density MCU is less compressible than the relatively low density MCU and therefore absorbs loads and dampens vibrations less than relatively low density MCU.

It is advantageous to produce an MCU insulator that has an increased block height without affecting the load absorption and vibration dampening characteristics of the insulator. This problem has been solved in the prior art by adding additional parts to the MCU insulator. For example, the U.S. Pat. No. 5,467,970 to Ratu et al. (the '970 patent) discloses an insulator including an outer bumper formed of microcellular urethane. The outer bumper defines a cavity and a rubber bumper is disposed in the cavity. The outer bumper absorbs loads and dampens vibration and the rubber bumper provides rigidity to decrease the compressibility of the insulator. The presence of multiple parts and the labor required to assemble the multiple parts increases the cost of manufacturing such insulators.

Accordingly, it would be desirable to manufacture the insulator that has an increased block height without affecting the load absorption and vibration dampening characteristics in a more efficient manner than contemplated by the prior art.

### SUMMARY OF THE INVENTION AND ADVANTAGES

The present invention is an insulator for a vehicle. The insulator includes a first portion extending along an axis, a second portion extending along the axis, and an intermediate portion disposed between the first portion and the second portion along the axis. The first portion defines a first density, the second portion defines a second density different from the first density, and the intermediate portion defines a transitional density transitioning between the first density of the first portion and the second density of the second portion. The first portion, the second portion, and the intermediate portion are integrally formed of a common homogeneous microcellular polyurethane material for defining a one-piece insulator having different densities.

Accordingly, the insulator has varying density such that the insulator has an increased block height without adversely affecting the load absorption and vibration dampening characteristics of the insulator. In addition, because the insulator is integrally formed of common homogeneous microcellular polyurethane material, i.e. a one-piece insulator, the cost to manufacture the insulator is decreased.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial cross-sectional side view of a first wheel suspension system for a vehicle having an insulator in the form of a jounce bumper;

FIG. 2 is a perspective view of the jounce bumper;

FIG. 3 is a cross-sectional view of the jounce bumper taken along line 3-3 of FIG. 2;

FIG. 4 is a graph illustrating an exemplary load deflection curve of different types of jounce bumpers;

FIG. 5 is a cross-sectional side view of a mount assembly for a vehicle having an insulator in the form of a body insulator;

FIG. 6 is a perspective view of the body insulator;

FIG. 7 is a cross-sectional view of the body insulator taken along line 7-7 of FIG. 6;

FIG. 8 is a cross-sectional side view of a second wheel suspension system for a vehicle having an insulator in the form of a coil spring isolator;

FIG. 9 is a perspective view of the coil spring isolator; and

FIG. 10 is a cross-sectional view of the coil spring isolator taken along line 10-10 of FIG. 9.

### DETAILED DESCRIPTION OF THE INVENTION

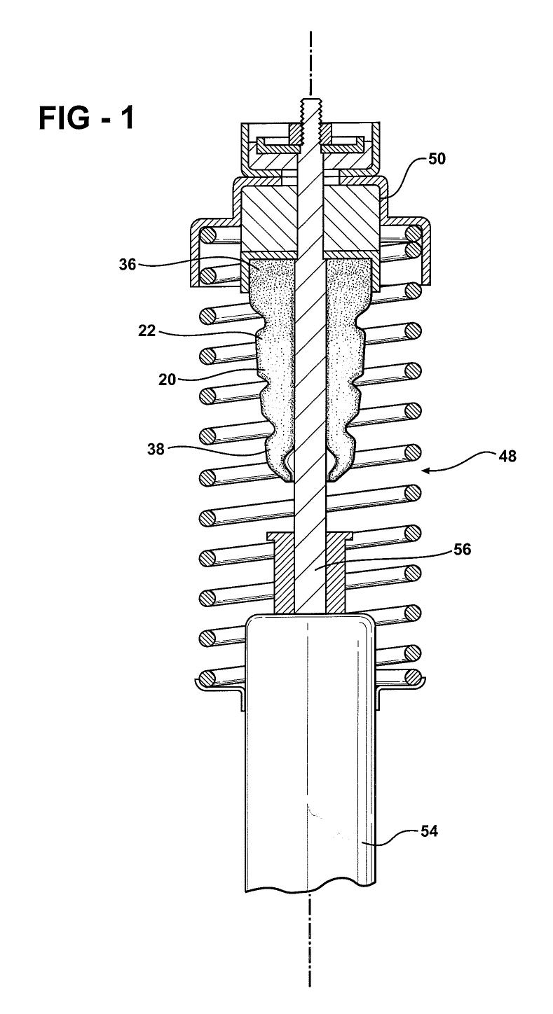

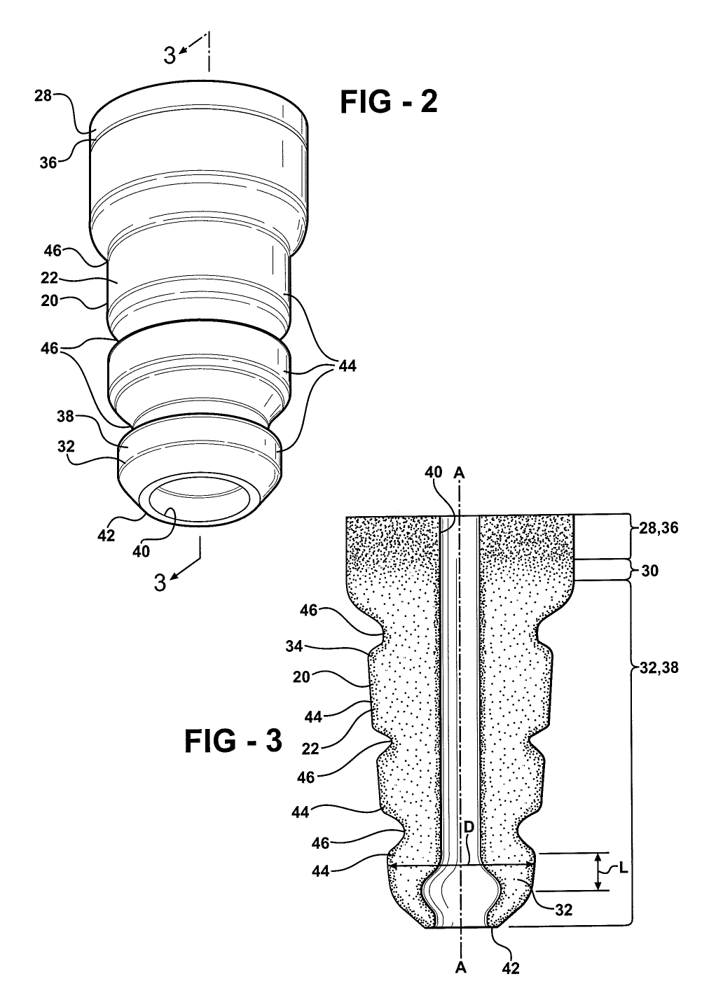

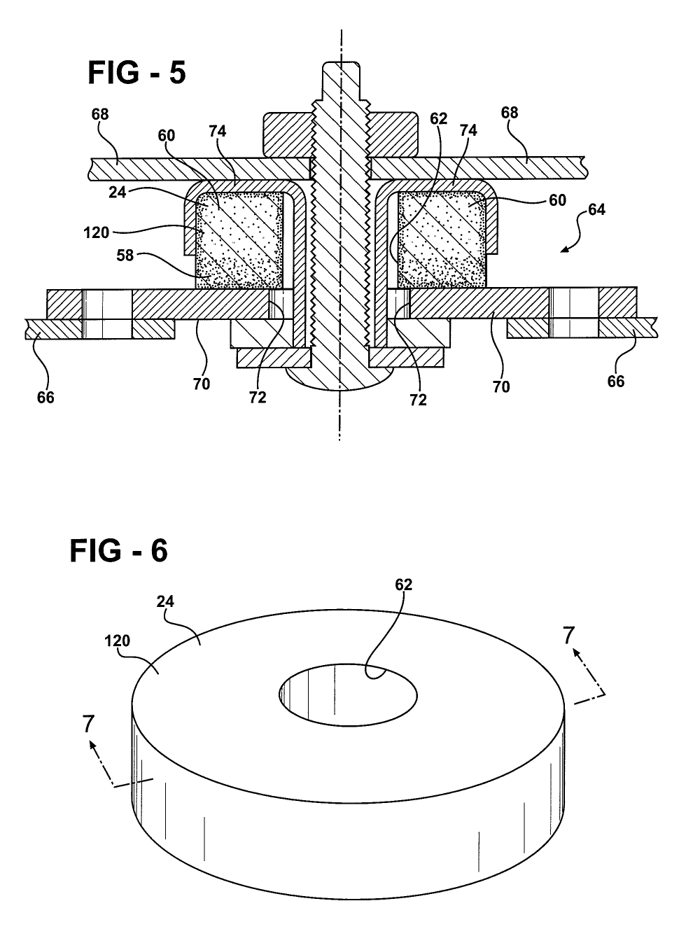

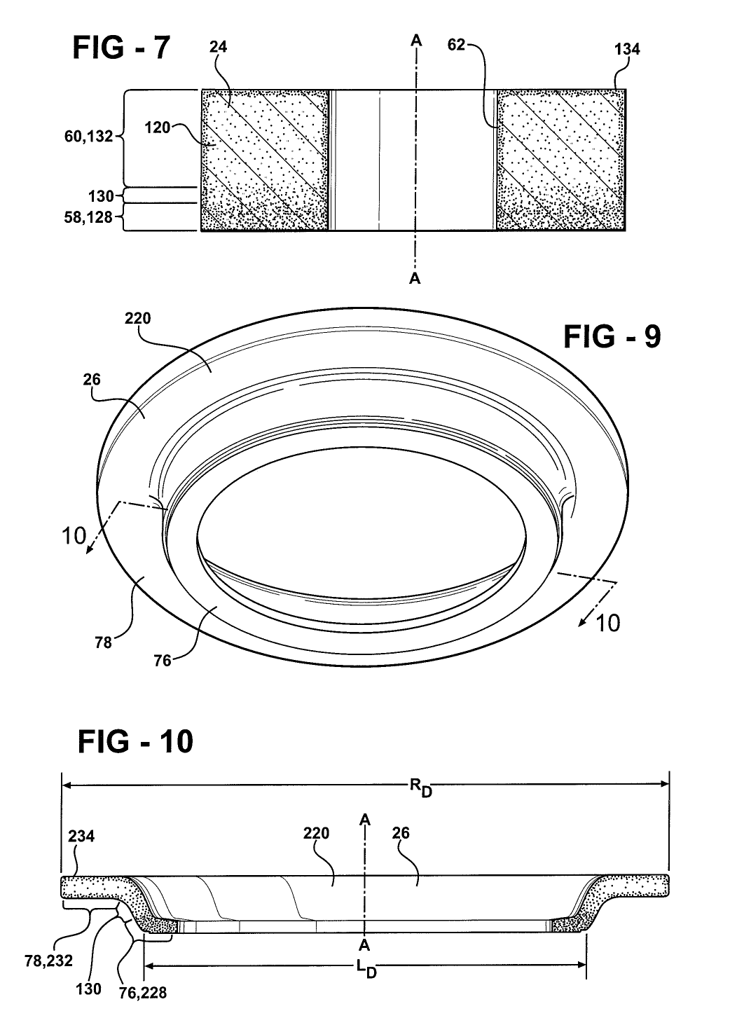

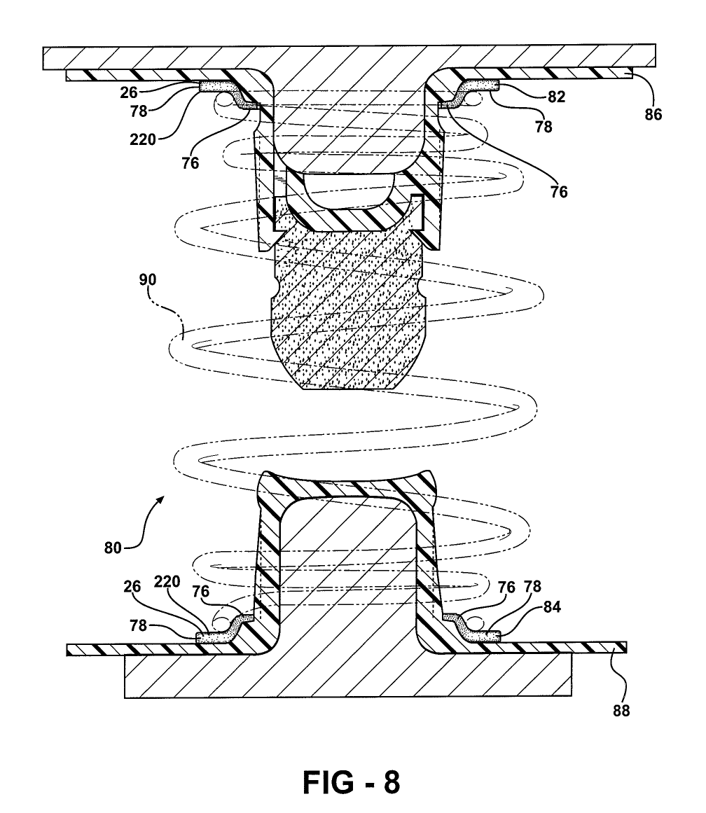

Referring to the Figures, wherein like numerals indicate like or corresponding parts throughout the several views, an insulator is shown generally at 20, 120, 220. In a first embodiment shown in FIGS. 1-3, the insulator 20 is further defined as a jounce bumper 22. In a second embodiment shown in FIGS. 5-7, the insulator 120 is further defined as a body insulator 24, i.e. a shock insulator. In a third embodiment shown in FIGS. 8-10, the insulator 220 is further defined as a coil spring isolator 26. It should be appreciated the first, second, and third embodiments are exemplary and the insulator is not limited to such embodiments. The insulator 20, 120, 220 of the present invention is preferably formed by a method disclosed in the United States patent application titled “Method of Deforming a Microcellular Polyurethane Component” filed by Dickson et al. on the same day as the present application. However, it should be appreciated that the insulator 20, 120, 220 may be formed by any method.

Although the invention is illustrated in different configurations in the first, second, and third embodiments, the insulators 20, 120, 220 in each of the embodiments include common features. The features common to each of the embodiments will be discussed prior to the discussion of each embodiment. To enhance consistency, the reference numerals of the common features of the insulator 20, 120 220 in the first embodiment have been increased by 100 in the second embodiment, and increased by 200 in the third embodiment.

As shown in FIGS. 3, 7, and 10, the insulator 20, 120, 220 includes a first portion 28, 128, 228 extending along an axis A, a second portion 32, 132, 232 extending along the axis A, and an intermediate portion 30, 130, 230 disposed between the first portion 28, 128, 228 and the second portion 32, 132, 232 along the axis A. The first portion 28, 128, 228 defines a first density and the second portion 32, 132, 232 defines a second density different from the first density. The intermediate portion 30, 130, 230 has a transitional density transitioning between the first density of the first portion 28, 128, 228 and the second density of the second portion 32, 132, 232.

Preferably, the first density of the first portion 28, 128, 228 is greater than the second density of the second portion 32, 132, 232 such that the compressibility of the second portion 32, 132, 232 is greater than the compressibility of the first portion 28, 128, 228. In other words, second portion 32, 132, 232 deforms more than the first portion 28, 128, 228 when subject to a load. Preferably the first density of the first portion 28, 128, 228 is further defined as being between 450 Kg/m³ and 1050 Kg/m³. Preferably, the second density of the second portion 32, 132, 232 is further defined as being between 300 Kg/m³ and 700 Kg/m³.

The first portion 28, 128, 228, the second portion 32, 132, 232, and the intermediate portion 30, 130, 230 are integrally formed of a common homogeneous microcellular polyurethane (MCU) material for defining a one-piece insulator 20 having different densities. In other words, the insulator 20, 120, 220 is a continuous unitary insulator 20, 120, 220 formed of MCU and having varying density within the insulator 20, 120, 220. For example, the MCU is of the type manufactured by BASF Corporation under the tradename Cellasto®. The MCU is a thermosetting material. In other words, once the MCU is formed and cured, the MCU is not meltable without permanently altering the chemical bonds and the physical properties of the MCU. Specifically, thermosetting material is defined by molecules that chemically bond with each other when heated. Thermosetting materials cannot melt without degrading because the melt temperature is higher than the chemical degradation temperature. More specifically, molecules of the thermosetting material cross-link with each other to create a permanent three-dimensional molecular network.

The MCU is formed from a two-step process. In the first step of the process, an isocyanate prepolymer is formed by reacting a polyol and an isocyanate. The polyol is polyester, and alternatively is polyether. The isocyanate is monomeric methyldiphenyl diisocyanate, and alternatively is naphthalene diisocyanate. In the second step of the process, the isocyanate prepolymer reacts with water to generate carbon dioxide and the carbon dioxide forms the cells of the MCU.

For example, polyester polyols are produced from the reaction of a dicarboxylic acid and a glycol having at least one primary hydroxyl group. For example, dicarboxylic acids that are suitable for producing the polyester polyols are selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. For example, glycols that are suitable for producing the polyester polyols are selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. The polyester polyol has a hydroxyl number of from 30 to 130, a nominal functionality of from 1.9 to 2.3, and a nominal molecular weight of from 1000 to 3000. Specific examples of polyester polyols suitable for the subject invention include Pluracol® Series commercially available from BASF Corporation of Florham Park, N.J.

For example, polyether polyols are produced from the cyclic ether propylene oxide, and alternatively ethylene oxide or tetrahydrofuran. Propylene oxide is added to an initiator in the presence of a catalyst to produce the polyester polyol. Polyether polyols are selected from the group of, but are not limited to, polytetramethylene glycol, polyethylene glycol, polypropylene glycol, and combinations thereof. The polyether polyol has a hydroxyl number of from 30 to 130, a nominal functionality of from 1.8 to 2.3, and a nominal molecular weight of from 1000 to 5000. Specific examples of polyether polyols suitable for the subject invention include Pluracol® 858, Pluracol® 538, Pluracol® 220, Pluracol® TP Series, Pluracol® GP Series, and Pluracol® P Series commercially available from BASF Corporation of Florham Park, N.J.

For example, diisocyanates are selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof. Specific examples of diisocyanates suitable for the subject invention include Lupranate® 5143, Lupranate® MM103, and Lupranate® R2500U commercially available from BASF Corporation of Florham Park, N.J.

The monomeric methyldiphenyl diisocyanate is selected from the group of 4,4′-diphenylmethane diisocyanate, 2,4′-diphenylmethane diisocyanate, and combinations thereof. Specific examples of monomeric methyldiphenyl diisocyanates suitable for the subject invention include Lupranate® M and Lupranate® MS commercially available from BASF Corporation of Florham Park, N.J. The monomeric methyldiphenyl diisocyante may also be modified with carbonimide. Specific examples of carbonimide-modified monomeric methyldiphenyl diisocyante include Lupranate® 5143 and Lupranate® MM103 commercially available from BASF Corporation of Florham Park, N.J.

Preferably, the insulator 20, 120, 220 presents a skin of increased density 34, 134, 234 continuous with and surrounding the first portion 28, 128, 228, the intermediate portion 30, 130, 230, and the second portion 32, 132, 232. Specifically, when the insulator 20, 120, 220 is formed from MCU, the skin of increased density 34, 134, 234 results from the forming process. Because the insulator 20, 120, 220 has the skin of increased density 34, 134, 234, the insulator 20, 120, 220 is more resistant to slicing, abrasion, and wear.

In the first embodiment, as shown in FIGS. 1-3, the first portion 28 is a shoulder portion 36 and the second portion 32 is a projection portion 38 such that the insulator 20 defines the jounce bumper 22. The intermediate portion 30 extends between the shoulder portion 36 and the projection portion 38. Specifically, the shoulder portion 36 extends along the axis A, the projection portion 38 extends along the axis A, and the intermediate portion 30 is disposed between the shoulder portion 36 and the projection portion 38 along the axis A.

The shoulder portion 36 defines the first density and the projection portion 38 defines the second density different from the first density. The intermediate portion 30 has a transitional density transitioning between the first density of the shoulder portion 36 and the second density of the projection portion 38.

Preferably, the first density of the shoulder portion 36 is greater than the second density of the projection portion 38 such that the compressibility of the projection portion 38 is greater than the compressibility of the shoulder portion 36. In other words, the projection portion 38 deforms more than the shoulder portion 36 when subject to a load. Preferably, the first density of the shoulder portion 36 is further defined as being between 450 Kg/m³ and 1050 Kg/m³. Preferably, the second density of the projection portion 38 is further defined as being between 300 Kg/m³ and 700 Kg/M³.

More specifically, the shoulder portion 36, the intermediate portion 30, and the projection portion 38 are integrally formed of common homogeneous MCU material for defining a one-piece jounce bumper 22 having different densities. In other words, the jounce bumper 22 is a continuous unitary jounce bumper 22 formed of MCU and having varying density within the jounce bumper 22.

Preferably, the jounce bumper 22 includes the skin of increased density 34 continuous with and surrounding the shoulder portion 36, the intermediate portion 30, and the projection portion 38. The skin of increased density 34 increases resistance to slicing, abrasion, and wear.

As shown in FIGS. 1-3, the shoulder portion 36 is preferably cylindrical. Preferably, the jounce bumper 22 defines a bore 40 being cylindrical and extending along the axis A through the jounce bumper 22.

As shown in FIGS. 1-3, preferably, the projection portion 38 is generally cylindrical and has a free end 42 and a plurality of annular rings 44 spaced along the axis A with a plurality of valleys 46 disposed between each of the annular rings 44 for varying the compressibility of the projection portion 38 along the axis A. As shown in FIG. 3, each of the annular rings 44 defines a ring diameter D and the ring diameter D of each of the annular rings 44 is progressively larger relative to the ring diameter D of each of the annular rings 44 spaced therefrom toward the free end 42 along the axis A. Each of the annular rings 44 defines a length L along the axis A and the length L along the axis A of each of the annular rings 44 is progressively larger relative to the length L along the axis A of each of the annular rings 44 spaced therefrom toward the free end 42 along the axis A. Alternatively, each of the annular rings has a common ring diameter D and length L. Due to the ring diameter D and length L along the axis A, annular rings 44 spaced toward the free end 42 are more compressible than rings spaced toward the shoulder portion 36, i.e. the annular ring 44 with a larger cross-section and a longer length L along the axis A deforms less under a load than the annular ring 44 with a smaller ring diameter D and a shorter length L along the axis A.

As shown in FIG. 1, the jounce bumper 22 is disposed in a first wheel suspension system 48 for a vehicle (not shown). The first wheel suspension system 48 is only partially illustrated in FIG. 1. As mentioned above, it should be appreciated that the jounce bumper 22 of the present invention is not limited to the first wheel suspension system 48 described herein, but may be disposed in any type of wheel suspension system.

The first wheel suspension system 48 includes a suspension support structure 50 for mounting the first wheel suspension system 48 to the vehicle, a piston rod 56, a shock tube 54, and the jounce bumper 22. The piston rod 56 extends from the suspension support structure 50 along the axis A. A shock tube 54 is disposed about the piston rod 56 and is moveable toward and away from the suspension support structure 50 along the axis A. In other words, the piston rod 56 is telescopically received in the shock tube 54 and is telescopically slideable such that the piston rod 56 and the shock tube 54 are extendable and retractable relative to one another.

The jounce bumper 22 is mounted to the suspension support structure 50 about the piston rod 56 for isolating impacts between the shock tube 54 and the suspension support structure 50. Specifically, the bore 40 of the jounce bumper 22 receives the piston rod 56 and the jounce bumper 22 is disposed along the piston rod 56 adjacent to the suspension support structure 50. As the piston rod 56 retracts into the shock tube 54, the shock tube 54 approaches the suspension support structure 50 and applies a load to and compresses the jounce bumper 22.

As the load increases and the projection portion 38 is further compressed, the load is transmitted through the projection portion 38 to the shoulder portion 36. Because the shoulder portion 36 is less compressible than the projection portion 38, when a load is applied to the projection portion 38, the projection portion 38 compresses more than the shoulder portion 36 compresses.

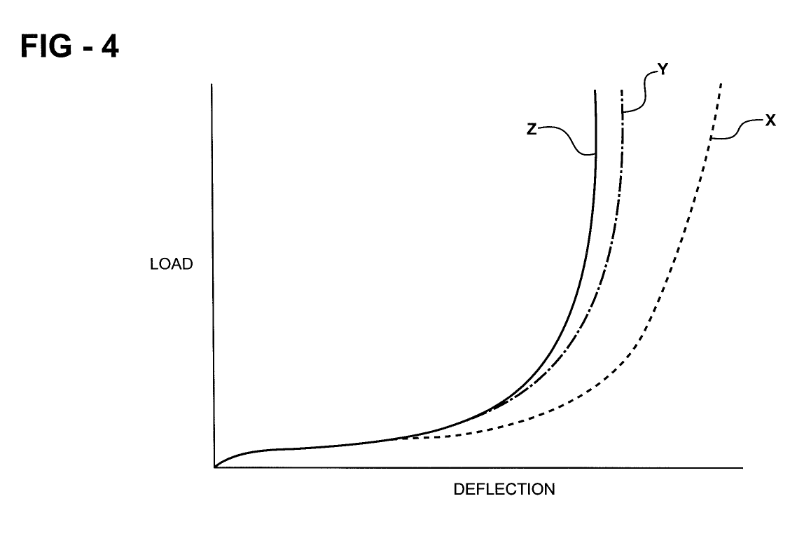

FIG. 4 shows an exemplary load/deflection curve for a tall jounce bumper having uniform density, a short jounce bumper having uniform density, and a short jounce bumper 22 of the present invention, i.e. with the shoulder portion 36, the intermediate portion 30, and the projection portion 38 being integrally formed of common homogeneous MCU material with the shoulder portion 36 defining the first density and the projection portion 38 defining the second density different than the first density. Specifically, Line X corresponds to the tall jounce bumper having uniform density, Line Y corresponds to the short jounce bumper having uniform density, and Line Z corresponds to the short jounce bumper 22 of the present invention. Both the short jounce bumper having uniform density and the short jounce bumper 22 of the present invention have the same height measured along the axis A and are shorter than the tall jounce bumper of uniform density measured along the axis A. Preferably, according to the method disclosed in the United States Patent Application titled “Method of Deforming a Microcellular Polyurethane Component” filed by Dickson et al. on the same day as the present application, the short jounce bumper 22 of the present invention is formed from an insulator similar in shape and size as the tall jounce bumper of uniform density

As shown in FIG. 4, when subject to small loads, the short jounce bumper 22 of the present invention has a similar load/deflection curve as that of the short jounce bumper of uniform density and the tall jounce bumper of uniform density. As the load increases, the short jounce bumper 22 of the present invention compresses less than the short jounce bumper of uniform density and the tall jounce bumper of uniform density.

Accordingly, the jounce bumper 22 of the present invention has advantageous impact isolating characteristics. Specifically, because the projection portion 38 is more compressible than the shoulder portion 36, the projection portion 38 absorbs loads exerted by the shock tube 54. Because the shoulder portion 36 is less compressible than the projection portion 38, the shoulder portion 36 provides an increased block height. The block height is the height of the jounce bumper 22 when the jounce bumper 22 is fully compressed, i.e. when the jounce bumper 22 can not be compressed further. In other words, due to the varying density of the jounce bumper 22, the jounce bumper 22 has the combination of favorable characteristics, specifically the ability to isolate impacts as well as having an increased block height. The jounce bumper 22 may be optimized for specific applications by varying the height of the jounce bumper 22, the first density of the shoulder portion 36, and the second density of the projection portion 38 such that the jounce bumper 22 has favorable impact isolation and block height characteristics.

In the second embodiment, as shown in FIGS. 5-7, the first portion 128 is a bottom portion 58 and the second portion 132 is a top portion 60 such that the insulator 120 defines the body insulator 24. The intermediate portion 130 extends between the bottom portion 58 and the top portion 60.

Specifically, the bottom portion 58 extends along the axis A, the top portion 60 extends along the axis A, and the intermediate portion 130 is disposed between the bottom portion 58 and the top portion 60 along the axis A,

The bottom portion 58 portion defines the first density and the top portion 60 defines the second density different from the first density. The intermediate portion 130 has the transitional density transitioning between the first density of the bottom portion 58 and the second density of the top portion 60.

Preferably, the first density of the bottom portion 58 is greater than the second density of the top portion 60 such that the compressibility of the top portion 60 is greater than the compressibility of the bottom portion 58. In other words, the top portion 60 deforms more than the bottom portion 58 when subject to a load. Preferably, the first density of the bottom portion 58 is further defined as being between 450 Kg/m³ and 1050 Kg/m³. Preferably, the second density of the top portion 60 is further defined as being between 300 Kg/m³ and 700 Kg/m³.

Preferably, the body insulator 24 includes the skin of increased density 134 continuous with and surrounding the bottom portion 58, the intermediate portion 130, and the top portion 60. The skin of increased density 134 increases resistance to slicing, abrasion, and wear.

More specifically, the bottom portion 58, the intermediate portion 130, and the top portion 60 are integrally formed of common homogeneous MCU material for defining a one-piece body insulator 24 having different densities. In other words, the body insulator 24 is a continuous unitary body insulator 24 formed of MCU and having varying density within the body insulator 24.

Preferably, the body insulator 24 is generally cylindrical and defines an orifice 62 extending along the axis A through the body insulator 24.

As shown in FIG. 5, the body insulator 24 is disposed in a mount assembly 64 for use with a vehicle (not shown) having a frame 66 and a vehicle body 68. The mount assembly 64 includes a mount support structure 70 for mounting to the frame 66 of the vehicle and defining an aperture 72. Additionally, the mount assembly 64 includes a carrier 74 at least partially disposed within the aperture 72 wherein the mount support structure 70 is displaceable relative to the carrier 74 when the frame 66 moves relative to the vehicle body 68. The body insulator 24 is disposed between the mount support structure 70 and the carrier 74 for coupling the carrier 74 to the mount support structure 70. Specifically, the orifice 62 of the body insulator 24 at least partially receives the carrier 74.

Because the bottom portion 58 is less compressible than the top portion 60. The top portion 60 absorbs and is compressed by loads exerted on the body insulator 24 by the vehicle body 68. As the load increases and the top portion 60 is further compressed, the load is transmitted through the top portion 60 to the bottom portion 58. Because the bottom portion 58 is less compressible than the top portion 60, when a load is applied to the top portion 60, the top portion 60 compresses more than the bottom portion 58 compresses.

The body insulator 24 of the present invention has advantageous impact isolating characteristics. Specifically, because the top portion 60 defines the second density lower than the first density of the bottom portion 58, the top portion 60 absorbs loads and dampens vibrations exerted by the vehicle body 68. Because the bottom portion 58 is less compressible than the top portion 60, the bottom portion 58 provides an increased block height. The block height is the height of the body insulator 24 when the body insulator 24 is fully compressed, i.e. when the body insulator 24 can not be compressed further. In other words, due to the varying density of the body insulator 24, the body insulator 24 has the combination of favorable characteristics, specifically the ability to isolate impacts as well as having an increased block height.

In the third embodiment, the first portion 228 is a lip 76 and the second portion 232 is a rim 78 such that the insulator 220 defines the coil spring isolator 26. The intermediate portion 230 extends between the lip 76 and the rim 78.

Specifically, the lip 76 defines the first density and the rim 78 defines the second density. The intermediate portion 230 has the transitional density transitioning between the first density of the lip 76 and the second density of the rim 78.

Preferably, the first density of the lip 76 is greater than the second density of the rim 78 such that the compressibility of the rim 78 is greater than the compressibility of the lip 76. In other words, the rim 78 deforms more than the lip 76 when subject to a load.

More specifically, the lip 76, the intermediate portion 230, and the rim 78 are integrally formed of common homogenous MCU material for defining a one-piece coil spring isolator 26 having different densities. In other words, the coil spring isolator 26 is a continuous unitary coil spring isolator 26 formed of MCU and having varying density within the coil spring isolator 26.

Preferably, the coil spring isolator 26 includes the skin of increased density 234 continuous with and surrounding the lip 76, the intermediate portion 230, and the rim 78. The skin of increased density 234 increases resistance to slicing, abrasion, and wear.

Preferably, the coil spring isolator 26 is generally cylindrical and the lip 76 defines a lip diameter LD and the rim 78 defines a rim diameter RD larger than the lip 76 diameter

In the third embodiment, as shown in FIG. 8, the coil spring isolator 26 is preferably disposed in a second wheel suspension system 80 for the vehicle (not shown). Specifically, the coil spring isolator 26 is further defined as a first coil spring isolator 82 and a second coil spring isolator 84. The wheel suspension system includes a first spring seat 86 and a second spring seat 88. A coil spring 90 extends between the first spring seat 86 and the second spring seat 88. The first coil spring isolator 82 is disposed between the first spring seat 86 and the coil spring 90. The second coil spring isolator 84 is disposed between the second spring seat 88 and the coil spring 90. It should be appreciated that the coil spring isolator 26 of the present invention is not limited to the second wheel suspension system 80 described herein, but may be disposed in any type of wheel suspension system.

The coil spring isolator 26 absorbs loads and dampens vibrations from the coil spring 90. Specifically, because the rim 78 is more compressible than the lip 76, the rim 78 absorbs loads and dampens vibrations from the coil spring 90. Because the lip 76 is less compressible than the rim 78, the lip 76 has sufficient rigidity to maintain the coil spring 90 in position relative to the coil spring isolator 26. Specifically, the lip 76 has sufficient rigidity to prevent the coil spring 90 from moving in a plane generally perpendicular to the axis A of the coil spring isolator 26.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. An insulator for a vehicle, said insulator comprising:
a first portion defining a first density and extending along an axis;
a second portion defining a second density different from said first density and extending along said axis; and
an intermediate portion disposed between said first portion and said second portion along said axis defining a transitional density transitioning between said first density of said first portion and said second density of said second portion;
said first portion, said second portion, and said intermediate portion being integrally formed of a common homogeneous microcellular polyurethane material for defining a one-piece insulator having different densities.

2. The insulator as set forth in claim 1 wherein said first density of said first portion is greater than said second density of said second portion such that the compressibility of said second portion is greater than the compressibility of said first portion.

3. The insulator as set forth in claim 1 wherein said first density of said first portion is further defined as being between 450 Kg/m³ and 1050 Kg/m³.

4. The insulator as set forth in claim 1 wherein said second density of said second portion is further defined as being between 300 Kg/m³ and 700 Kg/m³.

5. The insulator as set forth in claim 1 wherein said insulator presents a skin of increased density continuous with and surrounding said first portion, said intermediate portion, and said second portion.

6. The insulator as set forth in claim 1 wherein said first portion is a shoulder portion and said second portion is a projection portion such that said insulator defines a jounce bumper.

7. The insulator as set forth in claim 6 wherein said shoulder portion is cylindrical.

8. The insulator as set forth in claim 7 wherein said projection portion is generally cylindrical having a free end and a plurality of annular rings spaced along said axis with a plurality of valleys disposed between each of said annular rings for varying the compressibility of said projection portion along said axis.

9. The insulator as set forth in claim 8 wherein each of said annular rings defines a ring diameter D and said ring diameter D of each of said annular rings is progressively larger relative to said ring diameter D of each of said annular rings spaced therefrom toward said free end along said axis.

10. The insulator as set forth in claim 9 wherein each of said annular rings defines a length along said axis and said length along said axis of each of said annular rings is progressively larger relative to said length along said axis of each of said annular rings spaced therefrom toward said free end along said axis.

11. The insulator as set forth in claim 10 wherein said jounce bumper defines a bore being cylindrical and extending along said axis through said jounce bumper.

12. The insulator as set forth in claim 1 wherein said first portion is a bottom portion and said second portion is a top portion such that the insulator defines a body insulator.

13. The insulator as set forth in claim 12 wherein said insulator is generally cylindrical and defines an orifice extending along said axis through said body insulator.

14. The insulator as set forth in claim 1 wherein said first portion is a lip and said second portion is a rim such that the insulator defines a coil spring isolator.

15. The insulator as set forth in claim 14 wherein said coil spring isolator is generally cylindrical and said lip defines a lip diameter and said rim defines a rim diameter larger than said lip diameter.

16. A wheel suspension system for a vehicle, said wheel suspension system comprising:
a suspension support structure for mounting said wheel suspension system to the vehicle;
a piston rod extending from said suspension support structure along an axis;
a shock tube disposed about the piston rod and moveable toward and away from said suspension support structure along said axis; and
a jounce bumper mounted to said suspension support structure about said piston rod for isolating impacts between said shock tube and said suspension support structure, said jounce bumper comprising;
a shoulder portion defining a first density and extending along said axis;
a projection portion defining a second density different from said first density and extending along said axis; and
an intermediate portion disposed between said shoulder portion and said projection portion along said axis defining a transitional density transitioning between said first density of said shoulder portion and said second density of said second portion;
said shoulder portion, said projection portion, and said intermediate portion being integrally formed of a common homogeneous microcellular polyurethane material for defining a one-piece jounce bumper having different densities.

17. The wheel suspension system as set forth in claim 16 wherein said first density of said shoulder portion is greater than said second density of said projection portion such that the compressibility of said projection portion is greater than the compressibility of said shoulder portion.

18. The wheel suspension system as set forth in claim 16 wherein said first density of said shoulder portion is further defined as being between 450 Kg/m³ and 1050 Kg/m³.

19. The wheel suspension system as set forth in claim 16 wherein said second density of said projection portion is further defined as being between 300 Kg/m³ and 700 Kg/m³.

20. A mount assembly for use with a vehicle having a frame and a vehicle body, said mount assembly comprising:
a mount support structure for mounting to the frame of the vehicle and defining an aperture;
a carrier at least partially disposed within said aperture wherein said mount support structure is displaceable relative to said carrier when the frame moves relative to the vehicle body; and
a body insulator disposed between said mount support structure and said carrier for coupling said carrier to said mount support structure, said body insulator comprising;
a bottom portion defining a first density and extending along an axis;
a top portion defining a second density different from said first density and extending along said axis; and
an intermediate portion disposed between said bottom portion and said top portion along said axis defining a transitional density between said first density of said bottom portion and said second density of said top portion; and
said bottom portion, said intermediate portion, and said top portion integrally formed of a common homogeneous microcellular polyurethane material for defining a one-piece body insulator having different densities.

21. The mount assembly as set forth in claim 20 wherein said first density of said bottom portion is greater than said second density of said top portion such that the compressibility of said top portion is greater than the compressibility of said bottom portion.

22. The mount assembly as set forth in claim 20 wherein said first density of said bottom portion is further defined as being between 450 Kg/M³ and 1050 Kg/M³.

23. The mount assembly as set forth in claim 20 wherein said second density of said top portion is further defined as being between 300 Kg/m³ and 700 Kg/m³.
